(19) United States
(12) Patent Application Publication
(10) Pub. No.: US 2026/0163460 A1
(43) Pub. Date: Jun. 11, 2026

(54) METHOD FOR REPAIRING A GENERATOR HAVING FORMER-WOUND COILS, GENERATOR AND WIND POWER INSTALLATION

(71) Applicant: Wobben Properties GmbH, Aurich (DE)

(72) Inventor: Mats Volles, Karlsruhe (DE)

(73) Assignee: Wobben Properties GmbH, Aurich (DE)

(21) Appl. No.: 19/180,285

(22) Filed: Apr. 16, 2025

(30) Foreign Application Priority Data
Apr. 16, 2024 (EP) 24170431.1

(51) Int. Cl. H02K 15/50; H02K 3/02; H02K 3/12; H02K 3/28; H02K 3/487; H02K 7/18; H02K 15/70

(52) U.S. Cl. CPC H02K 15/50; H02K 3/02; H02K 3/12; H02K 3/28; H02K 3/487; H02K 7/183; H02K 15/70; H02K 2215/00

(57) ABSTRACT

A generator repair method includes decoupling the first and second connections of a defective former-wound coil from two other former-wound coils; separating the first and second coil heads of the defective coil; opening a slot closing wedge that closes a first slot into which a first leg of the defective coil is inserted; removing the first leg of the defective coil from the first slot; inserting a first leg of a new coil with an electrical conductor made of copper or aluminum; inserting a new slot closing wedge into the first slot, wherein the first slot is closed by the new slot closing wedge in the direction of the air gap existing between the stator and rotor in the operating state; inserting resin into the first slot; connecting the first leg to a second leg; and coupling the first and second connections of the new and the two other coils.

### TECHNICAL FIELD

The present disclosure relates to a method for repairing a generator having former-wound coils. In particular, the present disclosure relates to a method for repairing a generator having former-wound coils for a wind power installation. Furthermore, the present disclosure relates to a generator, in particular a generator for a wind power installation, and a wind power installation.

### BACKGROUND

A wind power installation is a system that converts kinetic energy from wind into electrical energy and feeds it into a power grid. To convert the kinetic energy into electrical energy, the wind power installation comprises a generator with a rotor that is mounted to rotate about an axis of rotation relative to a stator. Depending on the position of the axis of rotation, a distinction is made between a horizontal and a vertical wind power installation. In the horizontal axis wind power installation, the axis of rotation is horizontal or substantially horizontal. In the vertical axis wind power installation, the axis of rotation is vertical or substantially vertical. Horizontal wind power installations are also known as horizontal axis wind power installations and vertical wind power installations are also known as vertical axis wind power installations.

Modern wind power installations generally relate to so-called horizontal axis wind power installations, in which the axis of rotation is substantially horizontal or inclined at an acute angle to the axis of rotation. Accordingly, the rotor blades preferably sweep over a rotor surface that extends substantially perpendicular to the axis of rotation. Furthermore, wind power installations have a nacelle which is arranged on a tower of the wind power installation so that it can rotate about a substantially vertical axis.

In an operating state of the wind power installation, the wind causes the rotor blades to rotate, which drives the rotor of a generator that is coupled to the rotor blades. In the operating state, the rotor blades and the rotor rotate relative to a stator of the generator. Due to the relative movement between the rotor and stator, the (electrical) generator produces electrical energy. In the operating state of the wind power installation, the wind power installation is set up at the installation site and is operated to convert the kinetic energy of the wind into electrical energy.

Wind turbines can be gearless or with a gearing. Gearless wind power installations in particular have generators with a large diameter. It is quite common for generators to have a diameter of 5 m and more. These generators can be designed as so-called internal rotors or as so-called external rotors. In the case of an internal rotor, the rotor of the generator, which rotates with the rotor blades, is arranged inside a fixed stator of the generator. In an external rotor, the rotor is arranged outside the stator. In the case of the external rotor, the stator is arranged in particular inside the rotor, preferably radially inwards in relation to the rotor. Regardless of the type of generator, generators are usually attached to the nacelle, in particular a machine carrier, of the wind power installation.

For example, generators of wind power installations are known from EP 3 311 471 B1, which have a stator and a rotatably mounted electrodynamic rotor. Stators are known which have a plurality of strands, each with a plurality of windings. These windings are produced with an insulated wire, for example made of copper. For this purpose, the wire of one strand is wound into the slots of the stator so that a strand is produced from a continuous piece of wire.

Former-wound coils are also known, which correspond to prefabricated turns of a conductive material and are inserted directly into the slots of a stator. The former-wound coils have connections that protrude beyond the stator slot, to which the individual former-wound coils are connected by soldering or welding, so that the desired electrical connection of the entire winding structure is achieved.

In the event of a defect, such as a short circuit to ground in the stator of a wind power installation generator, the generator is usually completely dismantled and taken to a factory. A crane is usually required for this. The repair work is generally based on the procedure that is also used for series production.

In one example, and in the event of a ground fault in the stator of a generator, the slot is opened and the insulation restored. To do this, the slot is cleared, i.e., all insulation materials and electrical conductors are removed and completely rebuilt. The final impregnation with a resin poses a particular challenge. Although the winding heads are coated with resin, moisture can then penetrate the slot when the repaired generator is in operation. In addition, during operation of the repaired generator, the electromagnetic forces acting in the generator can cause relative movements between the electrical conductors and the laminations forming the slots, which minimizes the service life of the repaired generator.

### SUMMARY

The present disclosure therefore addresses the problem of providing an improved solution. In some aspects, the present disclosure enables a cost-effective repair of a generator and a wind power installation and provides a generator and a wind power installation with an improved service life after the repair of the generator. Furthermore, in some aspects, the present disclosure enables repairing a generator and a wind power installation without completely dismantling the generator.

The objectives of the present disclosure are achieved according to a first aspect of the present disclosure by a method according to claim 1. The method according to claim 1 relates to a method for repairing a generator with former-wound coils. For example, the method according to claim 1 relates to a method for repairing a generator with former-wound coils of a wind power installation. The generator and/or the wind power installation can be designed as described at the outset or can be designed for the use described at the outset.

The generator to be repaired has a plurality of former-wound coils, each of which is formed by an electrical conductor. Each electrical conductor extends between a first connection and a second connection. The first connection of a former-wound coil is connected to the second connection of another former-wound coil. The electrical conductor forms two parallel legs that extend between a first and a second coil head, through which the two legs are connected to each other.

In principle, the first connection and/or the second connection can be designed for a force-fit and/or form-fit and/or integrally bonded connection. It may be preferred that the first connection of a former-wound coil and the second connection of another former-wound coil are connected to each other by a screw connection. Additionally or alternatively, it may be preferred that the first connection of a former-wound coil and the second connection of a further former-wound coil are connected to each other by a plug connection. In addition or alternatively, it is provided that the first connection of a former-wound coil and the second connection of a further former-wound coil are connected to one another by a welded connection.

If the first and second connection are connected to each other by means of a screw connection, it may be preferable for the first and/or second connection to have through-holes through which screws and/or threaded rods are passed. However, a type of connection shoe is also conceivable, in which the first and second connections are or can be connected to each other with one or more screws. For a plug connection, it may be preferable for the first connection to have a recess, for example a through-hole or the like, and for the second connection to have a projection, wherein the projection engages in the recess so that the first and second connections are or can be connected to each other.

Furthermore, the generator has a laminated core which has a plurality of slots extending in the axial direction parallel to the axis of rotation of the generator and parallel to each other between a first slot end and a second slot end. The slots are spaced apart in the circumferential direction in relation to the axis of rotation of the generator. The two legs of the former-wound coils are each inserted in one of the slots, which are closed by a slot closing wedge in the direction of an air gap existing between the stator and rotor in the operating state.

In a first step, the method according to the present disclosure comprises decoupling the connections of the defective former-wound coil from the neighboring former-wound coils. The decoupling step comprises loosening the connection between the first connection of one former-wound coil and the second connection of the other former-wound coil. For example, the decoupling step comprises loosening the screw connection and/or the plug connection and/or the welded connection. When loosening the screw connection, a screw nut may be turned off a screw or threaded rod. When releasing the plug connection, it is intended, for example, that the form-fit connection between the first and second connection is released by the projection of one connection no longer engaging in the recess of the other connection. Releasing a welded connection involves, for example, cutting the connection between the first and second connection. The separation is carried out, for example, by sawing, cutting, pinching or machining. This step thus makes it possible to detach the defective coil from the other former-wound coils in the position of the generator required for operation in order to replace the defective former-wound coil in the position of the generator required for operation.

In a further step, the coil head of the defective former-wound coil is cut off to gain access to the legs. The separation can be carried out by cutting, grinding or another suitable separation process. For example, it may be preferred that the same method and/or tool is used for the step of separating the coil heads as is used for decoupling the first and second connections of the former-wound coil from the two other of the plurality of former-wound coils. This step facilitates the dismantling of the defective former-wound coil.

In a further step, a slot closing wedge, which closes a slot in which a first leg of the defective former-wound coil is inserted, is cut open in order to release the leg from the slot. The separation is preferably carried out using suitable separation tools and/or methods. For example, the slot closing wedge can be cut open using a chisel. It is also conceivable that the separation step is carried out by cutting with a knife and/or sawing with a saw.

In a further step, the first leg of the defective former-wound coil is removed from the slot. This creates space for the installation of a leg of a new former-wound coil. The removal step may involve a peeling off and/or pulling out and/or another suitable method. The important thing in this step is to ensure that the slot is not damaged when the leg is removed.

After the first leg of the defective former-wound coil has been removed, a first leg of a new former-wound coil with an electrical conductor, for example copper or aluminum, is inserted into the slot from which the first leg of the defective former-wound coil has been removed. This ensures that the electrical properties of the generator are restored or maintained and the conductivity is improved.

In a further step, a new slot closing wedge is inserted into the slot into which the first leg of the new former-wound coil was inserted. The slot is closed by the new slot closing wedge in the direction of the air gap between the stator and rotor, which exists in the operating state. This ensures, among other things, that the former-wound coil is protected from the environment and is held in the laminated core.

In a further step, resin is introduced into the slot into which the first leg of the new former-wound coil has been inserted. The resin penetrates into the space between the first leg of the new former-wound coil and the wall or base of the slot. As the resin fills this space, the first leg of the former-wound coil is form-fittingly fixed in the slot of the laminated core.

In a further step, the first leg is connected to the second leg. This can be done by soldering, welding or other suitable methods. The second leg can be the second leg of the defective former-wound coil that does not have a defect. Alternatively, the second leg can be a newly inserted second leg of the new former-wound coil.

In a further step, the connections of the new former-wound coil are coupled with the connections of the neighboring former-wound coils to restore the current flow in the generator and complete the repair.

The method has the advantage that the thermal conductivity and insulation properties of repaired generators are also improved by the resin used. For example, this repair method makes it possible for the repaired generator to have thermal conductivity and insulation properties that correspond to a newly manufactured generator due to the resin introduced. Thus, in one aspect, the repair method is advantageous in that, due to the resin introduced, the generator in the slots with the newly inserted former-wound coil does not have poorer or at least significantly poorer thermal conductivity and insulation properties compared to the other slots.

In addition, this repair method has the advantage that the sensitivity to moisture is reduced and the service life of a generator repaired in this way is improved compared to generators repaired in the conventional way.

According to this method, the repair work can take place inside the generator or the generator housing. If necessary, a scaffold may be provided inside the housing for the repair work.

According to a preferred embodiment, the method comprises steps to replace a second leg of the defective former-wound coil with a second leg of a new former-wound coil and to restore the generator to an operational state.

Accordingly, the method according to this preferred embodiment comprises the steps of cutting a slot closing wedge, which closes a slot in which a second leg of the defective former-wound coil is inserted; removing the second leg of the defective former-wound coil from the slot; inserting a second leg of a new former-wound coil having a copper electrical conductor; inserting a new slot closing wedge into the slot into which the second leg of the new former-wound coil has been inserted, wherein the slot is closed by the new slot closing wedge in the direction of the air gap existing between the stator and the rotor in the operating state; and introducing resin into the slot into which the second leg of the new former-wound coil has been inserted.

The method steps which are carried out in relation to the second leg of the defective former-wound coil and the second leg of the new former-wound coil can be carried out analogously to the method steps or can be carried out using the means as previously described in relation to the first leg of the defective former-wound coil and the first leg of the new former-wound coil.

Furthermore, according to a preferred embodiment, the method comprises the step of dismantling pole shoes. For example, the pole shoes can be removed in order to gain access to other parts of the generator. Dismantling the pole shoes creates additional space, which facilitates repair or maintenance work on the generator. The pole shoes are structural elements that are typically made of magnetic material and are fitted around the laminated core of the generator.

In a further preferred embodiment, the method may comprise cleaning the slot from which the first leg of the defective former-wound coil has been removed and/or from which the second leg of the defective former-wound coil has been removed. The cleaning is carried out using appropriate cleaning agents and methods to ensure that all residues and contaminants are completely removed. This may include removing old insulation material, dirt or other debris that may have accumulated in the slots over time. Cleaning the slots will ensure that the new former-wound coils can be properly embedded and that there are no obstructions that could interfere with the proper functioning of the generator.

In a further preferred embodiment, the method may comprise inserting an insulating element into the slot from which the first leg of the defective former-wound coil has been removed and/or from which the second leg of the defective former-wound coil has been removed. In a preferred embodiment, the insulating element comprises or is insulating paper, but may also comprise another suitable insulating material. Preferably, the step of inserting the insulating element comprises enclosing the electrical conductor with an insulating element. Additionally or alternatively, it may be preferred that the step of inserting the insulating element comprises enclosing the corresponding leg. For example, it may be preferred that the step of inserting the insulating element comprises wrapping or taping the electrical conductor with insulating paper. Additionally or alternatively, it may be preferred that the step of inserting the insulating element comprises wrapping or taping the corresponding leg.

According to a further preferred embodiment, the method comprises making at least one through-hole into the new slot closing wedge(s). Several through-holes can also be made in one or more of the new slot closing wedges. The through-hole can be drilled using a suitable method.

According to a further preferred embodiment, the method comprises inserting or arranging a sealant between the laminated core and the slot closing wedge(s). Here, the one slot or the plurality of slots are sealed in the radial direction. It is therefore not possible for the resin to escape from the slot in the direction of the air gap during operation. In addition or alternatively, sealing of the slot(s) is preferably provided at the first slot end and/or at the second slot end, so that the resin is prevented from escaping from the slot(s) in the axial direction. Silicone, felt or even a fleece can be used as a sealant, for example. Inserting or arranging the sealant reduces the risk of the generator to be repaired being contaminated by resin leaking out of the slot. In addition, inserting or arranging the sealant has the advantage that resin can be pressed into the slot at a higher pressure.

Furthermore, according to a preferred embodiment, the method comprises mounting at least one resin supply valve on the one or more new slot closing wedges. A plurality of resin supply valves may also be mounted on the one or more new slot closing wedges. The one resin supply valve or the plurality of resin supply valves are preferably designed as lubricating nipples. The one resin supply valve or the plurality of resin supply valves can be mounted or inserted in the through-hole or the plurality of through-holes of the one or the plurality of new slot closing wedges. The resin can be distributed more evenly if a plurality of resin supply valves are used. However, this also increases the effort required to introduce the resin into the slot. This is because the resin press unit has to be moved more frequently. A smaller number of resin supply valves reduces the number of times the resin press unit has to be repositioned, thus reducing the effort required to introduce the resin into the slot.

In a further preferred development of the method, it is provided that the step of introducing resin into the slot(s) into which the first and/or the second leg(s) of the new former-wound coil has/have been inserted comprises the following steps: Providing a resin press unit. For example, the resin press unit can be specially designed for inserting resin into the slots. The resin press unit is then placed on the at least one resin feed valve. These valves serve as an interface between the resin press unit and the slots through which the resin is introduced. The mounted resin press unit is then actuated to introduce resin into the slot(s). By actuating the resin press unit, the resin is pressed into the slots with the required pressure, resulting in even distribution and complete filling of the slots with resin. In principle, it is conceivable to press the resin into the slot at a pressure of up to 1,000 bar.

In a further preferred embodiment, resin is introduced into the slot(s) into which the first and/or the second leg(s) of the new former-wound coil has/have been inserted until the introduced resin emerges from the slot(s) at the first slot end and/or at the second slot end. This ensures that the slots are completely filled with resin and that no cavities or air pockets remain. The slot is sealed by the pressed-in resin and the electrical conductor is fixed in the slot. In addition, the thermal conductivity of the slot is improved so that no impermissibly high temperatures occur in the slot.

Furthermore, according to a further preferred development, it is provided that the electrical conductor of the plurality of former-wound coils consists of or comprises aluminum. This means that the electrical conductor forming the plurality of former-wound coils is either made entirely of aluminum or contains aluminum in its composition. Additionally or alternatively, it is provided that the electrical conductor of the defective former-wound coil consists of or comprises aluminum.

In a further preferred embodiment, it is provided that the respective electrical conductor of the one or more former-wound coils comprises a plurality of layers, preferably two or three layers, wherein preferably the plurality of layers are connected to the first and second connections, wherein the one or more turns, preferably four turns, are formed. However, the former-wound coils may also be formed from less than four or more than four turns. For example, the former-wound coils can be formed from two or three turns. The former-wound coils can also be formed from five, six, seven, eight or nine turns, for example. The former-wound coils can be formed from 10 or more turns.

In a further preferred embodiment, the electrical conductor of the new former-wound coil or coils is or comprises a flat copper rod or strip or flat copper wire or stranded copper wire. Alternatively, the electrical conductor of the new former-wound coil or the new former-wound coils is or comprises an aluminum flat bar or an aluminum strip or an aluminum flat wire or an aluminum strand. Additionally or alternatively, the resin is a two-component electrical insulation resin. Preferably, the resin is designed to cure at an ambient temperature of at least 0° C., at least 10° C. and/or at most 50° C., and/or at most 30° C. Additionally or alternatively, it may be that the resin has a dynamic/kinematic viscosity of at least 500 mPA and/or a maximum of 10,000 mPA, of at least 1,000 mPA and/or a maximum of 3,000 mPA at a temperature of 19° C.

In a further preferred embodiment, it is provided that the step of removing the first and/or the second leg of the defective former-wound coil from the slot(s) is or comprises a removal, for example a peeling off, of the first and/or the second leg layer by layer and/or turn by turn.

According to a second aspect of the present disclosure, the problem mentioned at the outset is solved according to claim 15 by a generator, for example a generator for a wind power installation.

With regard to the advantages, variants and details of the second aspect of the present disclosure and its developments, reference is also made to the preceding description of the corresponding features of the method for repairing a generator with former-wound coils or the respective other aspects.

The generator according to the present disclosure is, for example, a generator for a wind power installation. The generator has a plurality of former-wound coils. Each former-wound coil is formed by an electrical conductor which extends between a first connection and a second connection. The first connection of a former-wound coil is connected to the second connection of another former-wound coil. The electrical conductor of each former-wound coil consists of two parallel legs that extend between a first and a second coil head. These legs are connected to each other. The legs can form the basic structure of the former-wound coil.

The generator may also have a laminated core. For example, it has a laminated core which is designed for a rotor or a stator of the generator. This laminated core has a plurality of slots extending in the axial direction parallel to the axis of rotation of the generator and parallel to one another between a first slot end and a second slot end, which are arranged at a distance from one another in the circumferential direction in relation to the axis of rotation. The laminated core has a plurality of slots that extend parallel to the axis of rotation of the generator in the axial direction. The slots are arranged parallel to each other and extend between a first slot end and a second slot end. They are spaced apart in the circumferential direction in relation to the axis of rotation of the generator.

The two legs of each former-wound coil are each inserted in one of these slots, which are closed by a slot closing wedge in the direction of the air gap between the stator and the rotor.

The electrical conductor of one or more former-wound coils of the multiple former-wound coils consists of aluminum or comprises aluminum. Preferably, the majority of the plurality of former-wound coils consists of or comprises aluminum. The electrical conductor of the at least one leg of the at least one former-wound coil of the plurality of former-wound coils is made of copper or comprises copper. The electrical conductors may also consist of other suitable materials.

According to a third aspect of the present disclosure, the object mentioned at the outset is solved according to claim 16 by a generator, for example, a generator for a wind power installation. According to this aspect, the generator has been repaired as described above using the method according to the present disclosure.

According to a fourth aspect of the present disclosure, the problem mentioned at the outset is solved according to claim 17 by a wind power installation. The wind power installation comprises a generator according to the second or third aspect of the present disclosure.

With regard to the advantages, variants and details of these further aspects of the present disclosure and its developments, reference is also made to the preceding description of the corresponding features of the method for repairing a generator with former-wound coils or the respective other aspects.

Example embodiments of the present disclosure are now described below with reference to the drawings. These are not necessarily intended to show the embodiments to scale; rather, where this is useful for explanation, the drawings are shown in schematized and/or slightly distorted form. Reference is made to the relevant prior art with regard to additions to the teachings directly recognizable from the drawings. It should be noted that various modifications and changes can be made to the shape and detail of an embodiment without departing from the general idea of the present disclosure. The description, the drawings and in the claims describe aspects of the present disclosure, both individually and in any combination. In addition, all combinations of at least two of the features disclosed in the description, the drawings and/or the claims fall within the scope of the present disclosure. The general idea of the present disclosure is not limited to the exact form or detail of the preferred embodiments shown and described below, or limited to any subject matter that would be limited as compared to the subject matter claimed in the claims. In the case of stated dimension ranges, values lying within the stated limits are also to be disclosed as limit values and can be used and claimed as desired. For the sake of simplicity, the same reference signs are used below for identical or similar parts or parts with identical or similar functions.

### BRIEF DESCRIPTION OF THE SEVERAL VIEWS OF THE DRAWINGS

Further advantages, features and details of the present disclosure will become apparent from the following description of the preferred embodiments and from the drawings; in which:

FIG. 1 is a schematic representation of a wind power installation;

FIG. 2 is a schematic side view of a generator of the wind power installation shown in FIG. 1 in sectional view;

FIG. 3a is a first schematic view of a former-wound coil in a preferred embodiment;

FIG. 3b is a second schematic view of the former-wound coil shown in FIG. 3a;

FIG. 4a is a perspective view of a detail of a stator in a preferred embodiment of the generator shown in FIG. 2;

FIG. 4b shows an example of a stator with six inserted former-wound coils;

FIG. 5a is a schematic side view of a detail of a generator in need of repair;

FIG. 5b is a schematic plan view of a detail of the generator in need of repair shown in FIG. 5a;

FIG. 6a shows a detail of the generator in FIG. 5a in need of repair with the defective former-wound coil removed;

FIG. 6b shows a detail of the generator in FIG. 5b in need of repair with the defective former-wound coil removed;

FIG. 7a shows a detail of the generator in FIGS. 5a and 6a in need of repair with a new former-wound coil fitted;

FIG. 7b shows a detail of the generator in FIGS. 5b and 6b in need of repair with the new former-wound coil fitted;

FIG. 8 shows a schematic block diagram of a method for repairing the generator shown in FIG. 2 in a first embodiment; and

FIG. 9 shows a schematic block diagram of a method for repairing the generator shown in FIG. 2 in a second embodiment.

### DETAILED DESCRIPTION

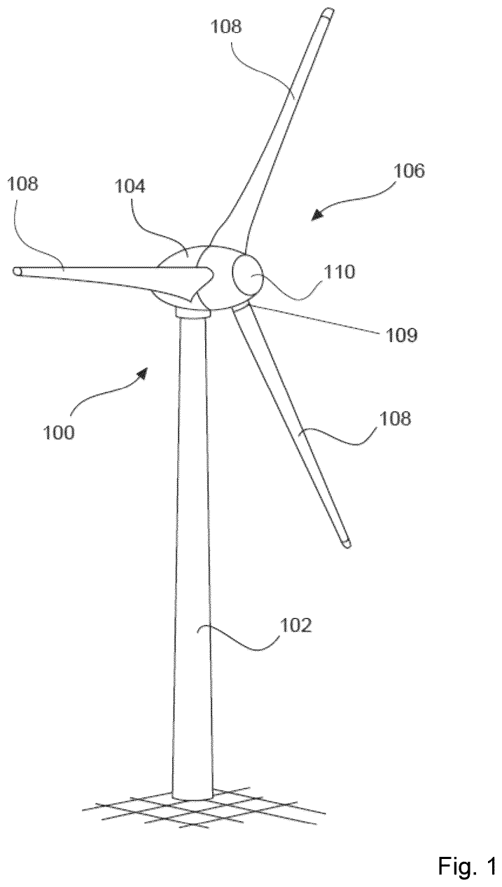

FIG. 1 shows a schematic representation of a wind power installation according to the present disclosure. The wind power installation 100 has a tower 102 and a nacelle 104 on the tower 102. An aerodynamic rotor 106 with three rotor blades 108 and a spinner 110 is provided on the nacelle 104. During operation of the wind power installation, the aerodynamic rotor 106 is set in rotation by the wind and thus also rotates a rotor or rotor of a generator, which is directly or indirectly coupled to the aerodynamic rotor 106. The electrical generator is arranged in the nacelle 104 and generates electrical energy. The pitch angles of the rotor blades 108 can be changed by pitch motors on the rotor blade roots 109 of the respective rotor blades 108.

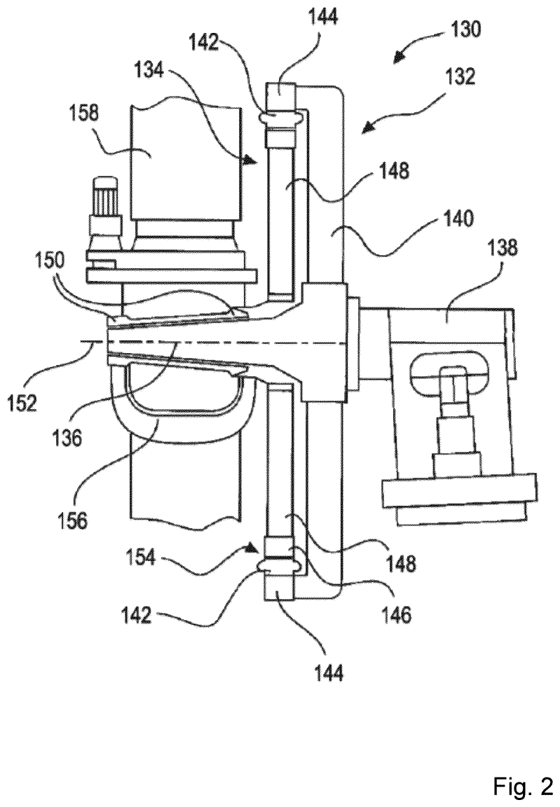

FIG. 2 shows a schematic side view of a generator 130. It has a stator 132 and an electrodynamic rotor 134 rotatably mounted with respect thereto and is fastened with its stator 132 to a machine carrier 138 via an axle journal 136. The stator 132 has a stator carrier 140 and stator laminated cores 142, which form the stator poles of the generator 130 and are attached to the stator carrier 140 via a stator ring 144.

The electrodynamic rotor 134 has rotor pole shoes 146, which form the rotor poles and are rotatably mounted on the axle journal 136 about the axis of rotation 152 via a rotor carrier 148 and bearing 150. The stator laminated cores 142 and rotor pole shoes 146 are separated only by a narrow air gap 154, which is a few millimeters thick, for example less than 6 mm, but has a diameter of several meters, for example more than 4 m.

The stator laminated cores 142 and the rotor pole shoes 146 each form a ring and together are also ring-shaped, so that the generator 130 is a ring generator. As intended, the electrodynamic rotor 134 of the generator 130 rotates together with the rotor hub 156 of the aerodynamic rotor, of which projections of rotor blades 158 are indicated.

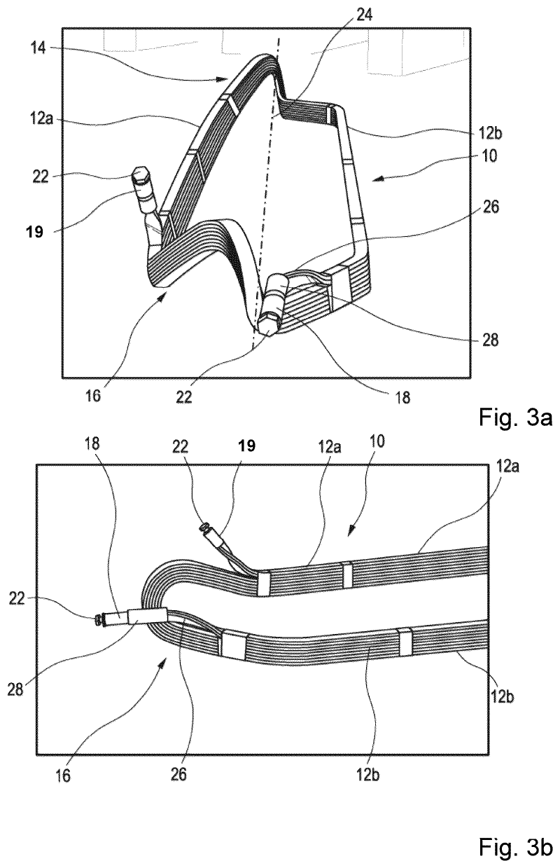

FIG. 3a shows a view of an exemplary embodiment of a former-wound coil 10. The former-wound coil 10 has two legs 12a, 12b. The legs 12a, 12b run parallel to each other and have a length of approximately 70 to 80 cm. The two legs 12a, 12b are connected to each other at a first end 14 and at a second end 16.

The second end 16 of the former-wound coil 10 has a first connection 18 and a second connection 19. The connections 18, 19 have an internal thread. Screws 22 are screwed into the internal thread of the connections 18, 19. The second connection 19 is angled with respect to a longitudinal axis 24 of the coil or parallel to the longitudinal axis 24 of the coil, and the first connection 18 is not angled.

The former-wound coil 10 comprises a conductor 26 and the connections 18 and 19, which are made of aluminum. Furthermore, the screws 22 are made of brass. The conductor 26 consists of two layers of flat wire, which are formed into four turns. This means that two layers of flat wire, also known as flat copper wire, are connected to the two connections 18, 19.

The former-wound coil 10 is thus formed with these two layers and four turns, so that eight layers of the flat copper wire are arranged or stacked on top of one another in the region of the legs 12a, 12b and in the region of the first end 14. It should be understood that, in principle, numbers of turns other than these are also possible.

Due to the outgoing connections 18, 19, six layers are still arranged on top of each other in the region of the second end 16. The flat wire is insulated by enameling. However, in the connection region of the conductor 26 with the connections 18, 19, the insulation has been removed in order to connect the connections 18, 19 to the conductor 26 by tungsten inert gas welding. In the region of the connection of the first connection 18 to the conductor 26, a glass-fiber reinforced plastic 28 is attached in order to re-insulate this part, which has been freed from the insulation of the conductor 26.

According to an exemplary embodiment not shown, such a glass fiber-reinforced plastic is also provided in the connecting part between the second connection 19 and the conductor 26. To ensure that the former-wound coil 10 retains its shape, the layers of the former-wound coil are wrapped in narrow regions. However, there is no insulation winding.

FIG. 3b shows a further view of the former-wound coil 10, wherein the second end 16 with part of the legs 12a, 12b is shown here from the side. The exemplary embodiment of the former-wound coil shown in FIG. 3b corresponds to the exemplary embodiment of the former-wound coil in FIG. 3a.

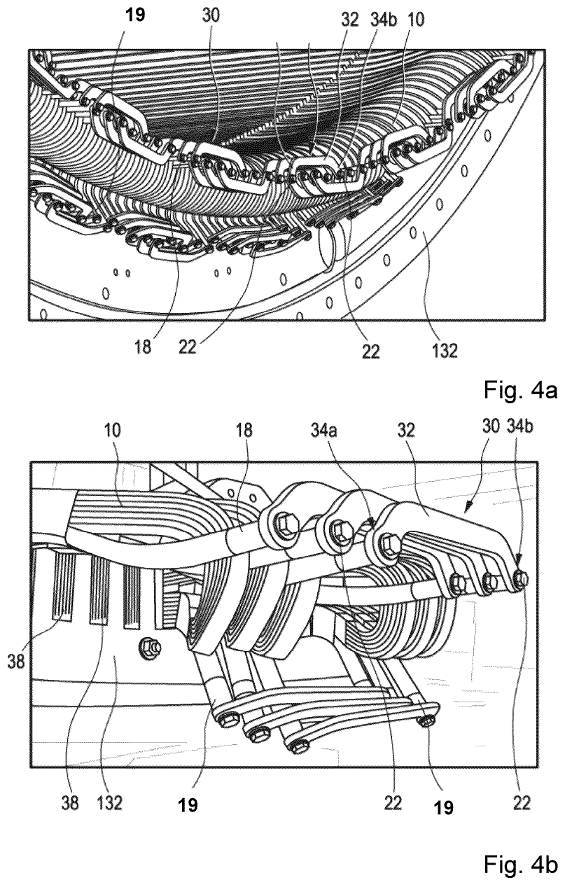

FIG. 4a shows a perspective view of a stator 132 of a generator 130 of a wind power installation 100 with former-wound coils 10. The former-wound coils 10 each have a first connection 18 and a second connection 19. The first connections 18 of the former-wound coils 10 are each connected to first connections 18 of other former-wound coils 10. The same applies to the second connections 19 of the former-wound coils 10.

The connections are made by connecting elements 30. The connecting elements 30 each comprise a flat bar 32, each of which has an aperture at its end 34a, 34b. These apertures are not visible in the illustration, as screws 22 are screwed into the connections 18, 19 through the apertures. The flat bars 32 have a U-shape, so that every sixth first connection 18 and every sixth second connection 19 is connected by such a connecting element 30, without the connecting element 30 being in contact with other connections 18, 19 which are not to be connected to each other. Therefore, the connecting elements 30 are not insulated. Alternatively, the connection can also be realized by a welded connection.

It can also be seen that the connecting elements 30 are arranged in different planes. This is possible because the connections 18, 19 of adjacent former-wound coils 10 protrude at different distances.

The connecting elements 30, which are connected to the second connections 19, have apertures which are spaced further apart than the apertures of the connecting elements 30, which are connected to the first connection 18. This is due to the fact that—starting from a center of the stator 132—the second connections 19 lie on a larger radius than the first connections 18.

Furthermore, the flat bars 32 of the connecting elements 30 are cranked or slightly angled so that the screws 22 can engage cleanly in the threads of the second connections 19. In principle, however, other configurations are also conceivable.

FIG. 4b shows an exemplary structure of a stator 132, in the slots 38 of which six former-wound coils 10 are inserted. The former-wound coils 10 are connected to each other by means of connecting elements 30. It should be noted here that the electrical connection is only made for the purpose of testing the screw connection. The connection of the coils in later use differs from the circuit shown and is therefore only exemplary. The circuit shown in FIG. 4b is a closed circuit, i.e., a short circuit. Specifically, all twelve connections of the six coils are connected to each other.

In the slots 38, which are not covered with former-wound coils 10 for reasons of representation, the laminated version of the stator 132 can also be seen in the left-hand region of the figure.

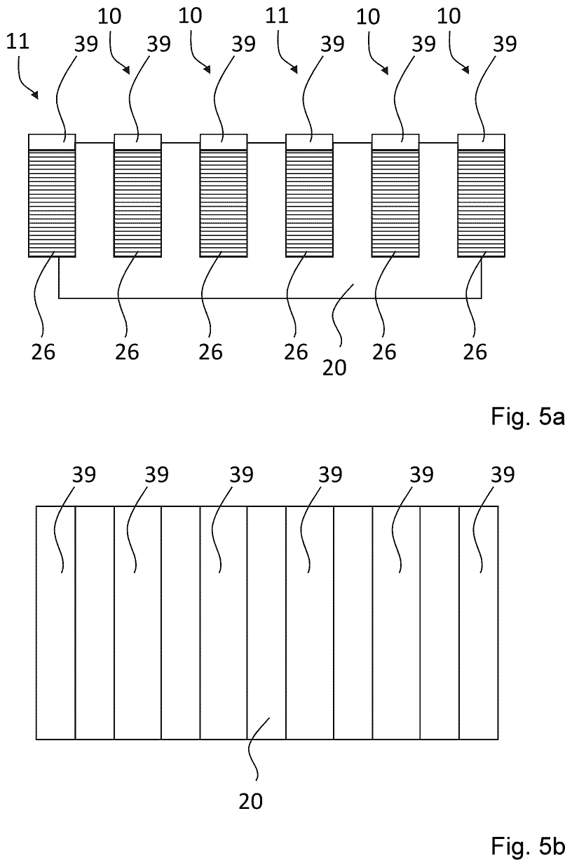

FIG. 5a shows a side view of a detail of an exemplary generator in need of repair with two intact former-wound coils 10 and one defective former-wound coil 11, each of which is formed by an electrical conductor 26. The former-wound coils 10, 11 are inserted into slots of a laminated core 20, wherein the slots 38 of the laminated core 20 are closed on the open side with slot closing wedges 39. The former-wound coils are thus enclosed in the slots 38 by the laminated core and the slot closing wedge. The electrical conductor extends between a first and second connection, as shown in FIGS. 3a to 4b.

FIG. 5b shows a detail of the exemplary generator in need of repair as shown in FIG. 5a in a schematic plan view of the inner circumferential side, wherein the slot closing wedges 39 are visible, which are seated in the slots of the laminated core 20.

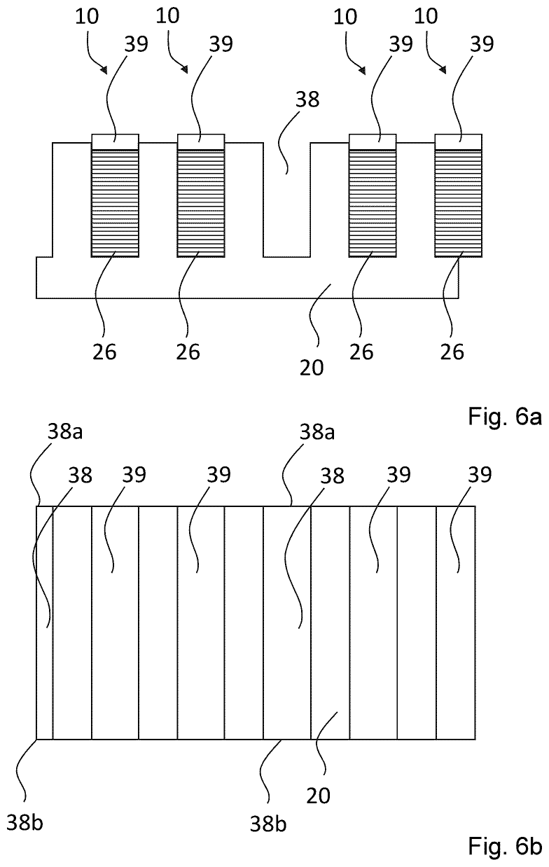

FIG. 6a shows the detail of the exemplary generator in need of repair with a dismantled defective former-wound coil 11, so that two slots 38 of the laminated core 20 are free or not occupied. The exemplary embodiment of the generator in need of repair shown in FIG. 6a corresponds to the exemplary embodiment in FIG. 5a.

FIG. 6b shows a detail of the exemplary generator in need of repair in a schematic plan view of the inner circumferential side with a dismantled defective former-wound coil. It can be seen from this view that the slots 38 extend between a first slot end 38a and a second slot end 38b. The exemplary embodiment of the generator in need of repair shown in FIG. 6b corresponds to the view in FIG. 5b, wherein the defective former-wound coil 11 and the slot closing wedges 39, which have covered the first and second legs 12a, 12b of the defective former-wound coil 11, have been removed.

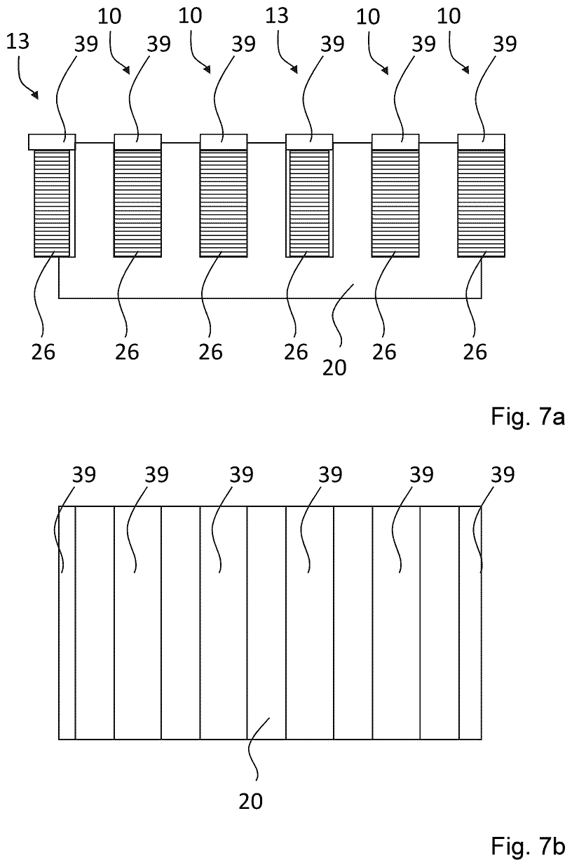

FIG. 7a shows a detail of the exemplary generator in need of repair with an assembled new former-wound coil 13, which has been inserted into the slots in which the defective coil 11 was previously inserted. The new former-wound coil 13 is constructed in the same way as the existing former-wound coils 10 and also consists of an electrical conductor 26 and is provided with slot closing wedges 39. The exemplary embodiment of the generator in need of repair shown in FIG. 7a corresponds to the exemplary embodiment in FIGS. 5a and 6a. FIG. 7b shows a schematic plan view of the inner circumferential side of the exemplary generator in need of repair with new former-wound coils fitted. The exemplary embodiment of the generator in need of repair shown in FIG. 7b corresponds to the views in FIGS. 5b and 6b.

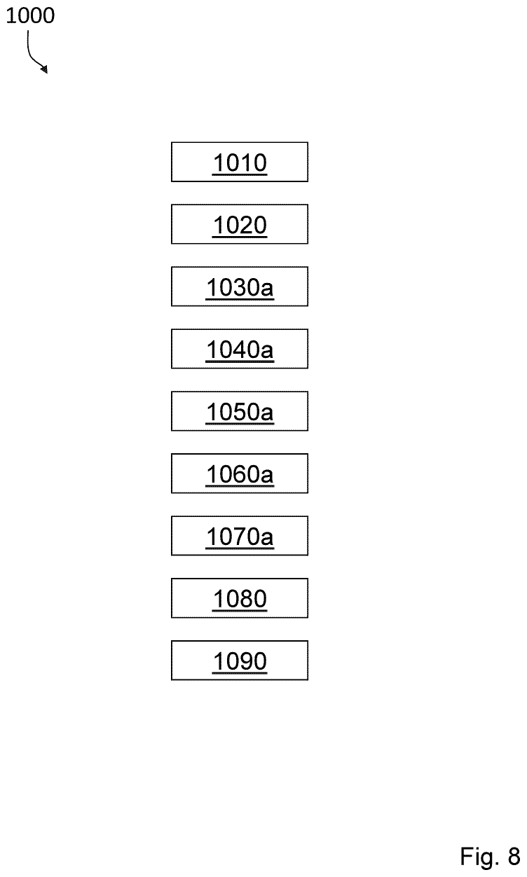

FIG. 8 shows a schematic block diagram of a method 1000 for repairing the generator shown in FIG. 2 in a first embodiment. In a first step, the method comprises decoupling 1010 the first connection 18 and second connection 19 of a defective former-wound coil 11 from two further of the plurality of former-wound coils 10. In a second step, the first coil head 14 and second coil head 16 of the defective former-wound coil 11 are separated 1020. Subsequently, the slot closing wedge 39, which closes a slot 38 in which a first leg 12a of a defective former-wound coil 11 is inserted, is separated 1030a. The first leg 12a of the defective former-wound coil 11 is then removed 1040a from the slot 38.

In a next step, a first leg 12a of a new former-wound coil 13 with an electrical conductor made of copper or aluminum is inserted 1050a. Subsequently, a new slot closing wedge 39 is inserted into the slot 38 1060a, into which the first leg 12a of the new former-wound coil 13 was inserted, wherein the slot 38 is closed by the new slot closing wedge 39 in the direction of the air gap existing between the stator and rotor in the operating state. Then, in step 1070a, resin is introduced into the slot 38 into which the first leg 12a of the new former-wound coil 13 has been inserted. The first leg 12a is then connected to the second leg 12b 1080. In a final step 1090, the first and second connections are coupled to the first and second connections of the two further former-wound coils 10.

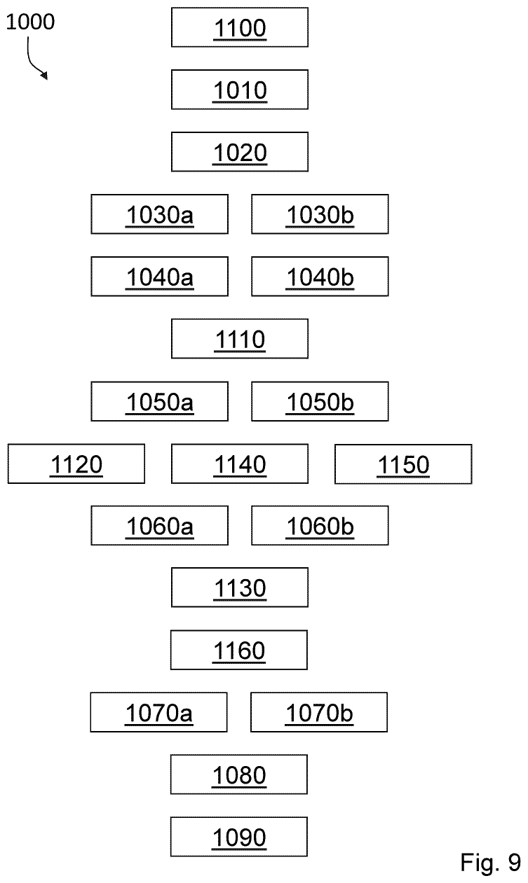

FIG. 9 shows a schematic block diagram of a method for repairing the generator shown in FIG. 2 in a second embodiment. In a first step, the method comprises decoupling 1010 the first 18 and second connection 19 of a defective former-wound coil 11 from two other of the plurality of former-wound coils 10. In a second step, the first 14 and second coil head 16 of the defective former-wound coil 11 are separated 1020. Subsequently, the slot closing wedge 39, which closes a slot 38 in which a first leg 12a of a defective former-wound coil 11 is inserted, is cut open 1030a, and/or the slot closing wedge 39, which closes a slot in which a second leg 12b of the defective former-wound coil 11 is inserted, is cut open 1030b. The first leg 12a of the defective former-wound coil 11 is then removed from the slot 38 1040a, and/or the second leg 12b of the defective former-wound coil 11 is removed from the slot 38 1040b. In step 1110, the slot or slots from which the first and second legs of the defective coil have been removed are cleaned.

In a next step, a first leg 12a of a new former-wound coil 13 with an electrical conductor 26 made of copper or aluminum is inserted 1050a and/or a second leg 12b of a new former-wound coil 13 with an electrical conductor 26 made of copper or aluminum is inserted 1050b. Thereafter, an insulating paper is inserted into the slot 1120 from which the first and/or the second leg of the defective former-wound coil was removed and/or a sealant is inserted in step 1140 between the laminated core 20 and the slot closing wedge(s) for sealing the slot(s) in the radial direction, so that an exit of the resin from the slot in the operating state in the direction of the air gap is prevented and/or in step 1050 the slot(s) is/are sealed at the first slot end and/or at the second slot end so that an exit of the resin from the slot(s) in the axial direction is prevented.

A new slot closing wedge 39 is then inserted 1060a into the slot 38, into which the first leg 12a of the new former-wound coil 13 was inserted, wherein the slot 38 is closed by the new slot closing wedge 39 in the direction of the air gap existing between the stator and rotor in the operating state and/or a new slot closing wedge 39 is inserted 1060b into the slot 38, into which the second leg 12a of the new former-wound coil 13 was inserted, wherein the slot 38 is closed by the new slot closing wedge 39 in the direction of the air gap existing between the stator and rotor in the operating state. Subsequently, in step 1030, at least one through-hole is made in the new slot closing wedge(s).

In step 1160, at least one resin supply valve is mounted, for example a lubricating nipple, on the new slot closing wedge(s), wherein the resin supply valve preferably is inserted into the through-hole. Then, in step 1070a, resin is introduced into the slot 38 into which the first leg 12a of the new former-wound coil 13 has been inserted and/or, in step 1070b, resin is introduced into the slot 38 into which the second leg 12a of the new former-wound coil 13 has been inserted. The first leg 12a is then connected to the second leg 12b 1080. In a final step 1090, the first and second connections are coupled to the first and second connections of the two further former-wound coils 10.

### LIST OF REFERENCE SIGNS

10 former-wound coil
11 defective former-wound coil
12a first leg
12b second leg
13 new former-wound coil
14 first end of a leg or first coil head
16 second end of a leg or second coil head
18 first connection of a former-wound coil
19 second connection of a former-wound coil
20 laminated core
22 screws
24 coil longitudinal axis
26 electrical conductor
28 glass-fiber-reinforced plastic
30 connecting element
32 flat bar
34a first end of a flat bar
34b second end of a flat bar
38 slot
38a first slot end
38b second slot end
39 slot closing wedge
100 wind power installation
102 tower
104 nacelle
106 aerodynamic rotor
108 rotor blade
109 rotor blade roots
110 spinner
130 generator
132 stator
134 electrodynamic rotor
136 axle journal
138 machine carrier
140 stator carrier
142 stator laminated core
144 stator ring
146 rotor pole shoe
148 rotor carrier
150 bearing
152 axis of rotation
154 air gap
156 rotor hub
158 rotor blade

1. A method for repairing a generator that includes a plurality of former-wound coils, each of which is formed by an electrical conductor that extends between a first connection of one of the plurality of former-wound coils that is connected to a second connection of another one of the plurality of former-wound coils, wherein the electrical conductor forms two parallel legs extending between first and second coil heads by which the two parallel legs are connected, the generator further including a laminated core for a rotor or a laminated core for a stator having a plurality of slots that extend in an axial direction parallel to an axis of rotation of the generator and parallel to one another between a first slot end and a second slot end, and which are arranged at a distance from one another in a circumferential direction with respect to the axis of rotation, wherein the two parallel legs of the former-wound coils are each inserted in one of the plurality of slots closed by a slot closing wedge in a direction of an air gap existing between the stator and the rotor in an operating state, the method comprising:
decoupling the first connection and the second connection of a defective former-wound coil from two other former-wound coils of the plurality of former-wound coils;
separating the first and second coil heads of the defective former-wound coil;
opening a slot closing wedge that closes a first slot ofo the plurality of slots into which a corresponding first leg of the defective former-wound coil is inserted;
removing the corresponding first leg of the defective former-wound coil from the first slot;
inserting a corresponding first leg of a new former-wound coil of the plurality of former-wound coils with an electrical conductor made of copper or aluminum;
inserting a new slot closing wedge into the first slot into which the corresponding first leg of the new former-wound coil has been inserted, wherein the first slot is closed by the new slot closing wedge in the direction of the air gap existing between the stator and rotor in the operating state;
inserting resin into the first slot into which the corresponding first leg of the new former-wound coil is inserted;
connecting the corresponding first leg to a corresponding second leg; and
coupling the first connection and the second connection of the new former-wound coil to the first connection and the second connection of the two other former-wound coils.

2. The method as claimed in claim 1, further comprising:
opening an additional slot closing wedge which closes a second slot of the plurality of slots into which a corresponding second leg of the defective former-wound coil is inserted;
removing the corresponding second leg of the defective former-wound coil (11) from the second slot (38);
inserting a corresponding second leg of the new former-wound coil with a copper electrical conductor;
inserting a new slot closing wedge into the second slot into which the corresponding second leg of the new former-wound coil has been inserted, wherein the second slot is closed by the new slot closing wedge in the direction of the air gap existing between the stator and rotor in the operating state; and
inserting resin into the second slot into which the corresponding second leg of the new former-wound coil is inserted.

3. The method as claimed in claim 1, further comprising:
dismantling pole shoes.

4. The method as claimed in claim 1, further comprising:
cleaning at least one of the first slot or the second slot from which the corresponding first leg or the corresponding second leg of the defective former-wound coil is removed.

5. The method as claimed in claim 4, further comprising:
inserting an insulating element into the at least one of the first slot or the second slot from which the corresponding first leg or the corresponding second leg of the defective former-wound coil has been removed.

6. The method as claimed in claim 1, further comprising:
creating at least one through-hole in the new slot closing wedge.

7. The method as claimed in claim 1, further comprising at least one of:
arranging a sealant between the laminated core and the slot closing wedge for sealing the plurality of slots in a radial direction to prevent the resin from scaping the first slot in the operating state in the direction of the air gap; or
sealing the plurality of slot at one or more of the first slot end and the second slot to prevent the resin from escaping from the first slot in the axial direction.

8. The method as claimed in claim 6, further comprising:
mounting at least one resin supply valve on the new slot closing wedge, wherein the resin supply valve is inserted into the at least one through-hole.

9. The method as claimed in claim 8, wherein inserting the resin comprises:
providing a resin press unit;
placing the resin press unit on the at least one resin supply valve; and
actuating the resin press unit to insert the resin.

10. The method as claimed in claim 2, wherein inserting the resin into the first slot and the second slot continues until the resin emerges from the corresponding first slot and the second slot at the corresponding first slot end or the corresponding second slot end.

11. The method as claimed in claim 1, wherein the electrical conductor of the plurality of former-wound coils includes aluminum.

12. The method as claimed in claim 1, wherein
the respective electrical conductor of the plurality of former-wound coils comprises a plurality of layers connected to the first and second connections, and
the plurality of former-wound coils are formed from multiple windings.

13. The method as claimed in claim 1, wherein
the electrical conductor of the new former-wound coil comprises:
a flat copper bar, a copper strip, a flat copper wire, or a stranded copper wire; or
an aluminum flat bar, an aluminum strip, an aluminum flat wire, or an aluminum strand; and
the resin is a two-component electrical insulation resin designed to cure at an ambient temperature between 0° C. and 50° C., and
the resin has a dynamic/kinematic viscosity of at least 500 mPa*s and at most 10,000 mPa*s at a temperature of 19° C.

14. The method as claimed in claim 1, wherein removing the corresponding first leg and the corresponding second leg of the defective former-wound coil from the first comprises a removal of the corresponding leg and the corresponding second leg layer by layer.

15. A generator for a wind power installation, comprising:
a plurality of former-wound coils each formed by an electrical conductor extending between a corresponding first connection and a corresponding second connection, wherein the corresponding first connection of a former-wound coil is connected to the corresponding second connection of another former-wound coil of the plurality of former-wound coils, wherein
the conductor forms two parallel legs extending between a first coil head and a second coil head, by which the two parallel legs are connected together; and
a laminated core for a rotor or a stator, which has a plurality of slots extending in an axial direction parallel to an axis of rotation of the generator and parallel to one another between a first slot end and a second slot end of each of the plurality of slots, wherein the plurality of slots are arranged at a distance from one another in a circumferential direction in relation to the axis of rotation;
the two parallel legs of the former-wound coils are each inserted in one of the plurality of slots which are closed by a slot closing wedge in a direction of an air gap between the stator and the rotor; and
the electrical conductor of the plurality of former-wound coils is made of aluminum or includes aluminum, and the electrical conductor of at least one leg of at least one former-wound coil of the plurality of former-wound coils is made of copper or comprises copper.

16. A generator for a wind power installation repaired in accordance with the method of claim 1.

17. (canceled)

18. A wind power installation comprising:
at least one generator comprising:
a plurality of former-wound coils each formed by an electrical conductor extending between a corresponding first connection and a corresponding second connection, wherein the corresponding first connection of a former-wound coil is connected to the corresponding second connection of another former-wound coil of the plurality of former-wound coils, wherein
the conductor forms two parallel legs extending between a first coil head and a second coil head, by which the two parallel legs are connected together; and
a laminated core for a rotor or a stator, which has a plurality of slots extending in an axial direction parallel to an axis of rotation of the generator and parallel to one another between a first slot end and a second slot end of each of the plurality of slots, wherein the plurality of slots are arranged at a distance from one another in a circumferential direction in relation to the axis of rotation;
the two parallel legs of the former-wound coils are each inserted in one of the plurality of slots which are closed by a slot closing wedge in a direction of an air gap between the stator and the rotor; and
the electrical conductor of the plurality of former-wound coils is made of aluminum or includes aluminum, and the electrical conductor of at least one leg of at least one former-wound coil of the plurality of former-wound coils is made of copper or comprises copper.
